(19) United States
(12) Patent Application Publication
(10) Pub. No.: US 2020/0128834 A1
(43) Pub. Date: Apr. 30, 2020

(54) System of gluten free flours

(71) Applicant: Millie j Westley, Stafford, VA (US)

(72) Inventor: Millie j Westley, Stafford, VA (US)

(73) Assignee: Millie J. Westley, Stafford, VA (US)

(21) Appl. No.: 16/170,074

(22) Filed: Oct. 25, 2018

(51) Int. Cl. A21D 13/066; A21D 13/047; A21D 10/00; A21D 2/18; A21D 2/36

(52) U.S. Cl. CPC A21D 13/066; A21D 13/047; A21D 2/366; A21D 2/181; A21D 10/005

(57) ABSTRACT

Food product compositions provide for gluten free or gluten-reduced food products having organoleptic properties that are the same or substantially the same as their gluten-containing food product counterparts, and related methods for making the compositions thereof.

At least one embodiment is gluten dry mix compositions consisting substantially of rice flour, sweet rice flour, oat flour, and millet flour, buckwheat flour, teff flour, potato flour, xanthan gum and maltodextrin.

At least one embodiment is gluten dry mix compositions consisting substantially of oat flour, and millet flour, buckwheat flour, teff flour, potato flour, xanthan gum and maltodextrin.

At least one embodiment is gluten dry mix compositions consisting substantially of rice flour, sweet rice flour, oat flour, and millet flour, buckwheat flour, teff flour, potato flour.

At least one embodiment is gluten dry mix compositions consisting substantially of oat flour, and millet flour, buckwheat flour, teff flour, potato flour.

At least one embodiment is gluten dry mix compositions consisting substantially of buckwheat flour, millet flour, teff flour, potato flour.

To any of the above coconut flour can be added for another embodiment.

### RELATED APPLICATIONS

This application claims the benefit under 35 U.S.C. § 119(e) of U.S. provisional patent application 62/412,282 filed on Oct. 25, 2016, the contents of which is incorporated herein by reference. And patent application Ser. No. 15,793,792 filed on Oct. 25, 2017, the contents of which is incorporated herein by reference.

### BACKGROUND OF THE INVENTION

Gluten is a protein composite found in foods processed from wheat and related species, including barley and rye. It imparts elasticity to dough, helping it to rise and to keep its shape, and often giving the final product a chewy texture.

When people with Celiac Disease eat foods containing gluten, their immune system responds by damaging tiny fingerlike protrusions, called villi. Villi lining the small intestines are responsible for the absorption of nutrients into the bloodstream. If villi become damaged or destroyed and are unable to absorb nutrients, a person becomes malnourished, irrespective of the quantity of the food consumed. The only medically accepted treatment for Celiac Disease is to follow a gluten-free diet, eliminating virtually all foods made from grains that contain gluten. It is difficult for individuals following such a diet to find gluten-free options, for example, at restaurants and local convenience stores. Others just feel better if they eat gluten free food.

### SUMMARY OF THE INVENTION

Embodiments herein include gluten-free baked products such as flour, mix, partially prepared products like doughs, ready to eat products, breads and gluten-free flour formulations, and related methods. Food products (e.g., bread, crackers, pizza dough, muffin, brownies) Some embodiments are a substitute for all-purpose flour in a group of recipes, hence a multipurpose flour. Other embodiment are mix, partially finished (like cookie dough), or ready to eat product, or anything in between.

In some embodiment, provided herein are Gluten free dry mix compositions comprising oat flour and one or more flour. In some embodiment, provided herein are Gluten free dry mix compositions comprising oat flour, millet flour. In some embodiment, provided herein are Gluten free dry mix compositions comprising oat flour, millet flour and one or more flour. In some embodiment, provided herein are Gluten free dry mix compositions comprising oat flour, coconut flour. Such flours could include, for example; vegetable flours, refined flours, whole or nearer whole grain flours. These could include, for example, rice flour, sweet rice flour, buckwheat flour, millet flour, coconut flour, grain flour, sorghum, teff flour, potato flour. In some aspects, provided herein are Gluten free dry mix compositions comprising oat flour, white rice flour, sweet rice flour, buckwheat, millet flour, potato flour. In some aspects, provided herein are Gluten free dry mix compositions comprising oat flour, millet flour, buckwheat, potato flour. In some embodiments, the Gluten free dry mix compositions further comprise one or more gums, such as xanthan gum, guar gum. In some embodiments, the Gluten free dry mix compositions further comprise ginger. In some embodiments, the Gluten free dry mix compositions further comprise an emulsifier or maltodextrin.

There are a wide range of wheat flours; all-purpose flour, cake flour, bread flour, high gluten flour, whole wheat flour, whole wheat bread flour. We can emulate this by adjusting the ratios of ingredients of the gluten free dry composition. In some embodiments, the percentage of one or more of the buckwheat, oat flour, less refined grain flour, less refined grain seed flour millet flour, is increased to get a higher fiber version. In some embodiments, the percentage of one or more of the buckwheat, oat flour, less refined grain flour, less refined grain seed flour, millet flour, is decreased to get a lower fiber version. In some embodiments, an ingredient is eliminated to adjust for those with additional restrictions. For example, but not limited to, in some embodiments, there are no rice flours. In some embodiments, the oat flour is present in an amount of about 50% to about 90% weight/weight (w/w) of the dry mix composition. In some embodiments, the oat flour is present in an amount of about 10% to about 50% weight/weight (w/w) of the dry mix composition. In some of said embodiments, there are not gums or emulisifiers. In some of said embodiments, there are gums and/or emulisifiers.

Hydrocolloids or gums, can be added to the dough formulation to give structure to the dough and bind ingredients (i.e., to create a suitable matrix within the dough in the absence of gluten). For example, hydrocolloids may be added to improve the rheology and crumb texture by stabilizing small air cells within the dough and bind to moisture Suitable hydrocolloids include xanthan gum, guar gum, locust bean gum, carrageenan gum and the like. In some embodiments, hydrocolloids or gums may be present in an amount from about 0.01% to about 2% by weight of the dough. Useful agents include sorbic acid and its derivatives such as sodium or potassium sorbate, propionic acid and its derivatives, vinegar, sodium diacetate, monocalcium phosphate, lactic acid, citric acid and the like. These agents are present in an amount effective to inhibit the growth of undesired yeast and/or molds, typically in amount from about 0.1% to about 0.2% by weight of the dough. Too little will not provide sufficient antimycotic effect, while too much can impart an off taste to the dough. In some embodiments, at least one of the following texture additions; xanthan gum, gaur gum, ginger, ascorbic acid, maltodextrin, dextrin, emulsifiers, psyllium, stabilizers, (including ones yet to be determined) is present in an amount ranging between about 0.001% w/w and about 5% w/w or of about 1% w/w of the dry mix composition is texture additions. In some embodiment there are no texture additions. In some embodiment there is very little texture additions.

In some aspects, provided herein are gluten-free dry mix compositions consist essentially oat flour are present in an amount of about 50% to about 90% weight/weight (w/w) of the dry mix composition; millet flour, buckwheat and/or grain flour, and potato flour are collectively present in an amount of about 10% to about 50% w/w of the dry mix composition; with or without texture additions in an amount of about 1% w/w of the dry mix composition. In some aspects, provided herein are gluten-free dry mix compositions consist essentially oat flour are present in an amount of about 10% to about 50% weight/weight (w/w) of the dry mix composition; millet flour, buckwheat and/or grain flour, and potato flour are collectively present in an amount of about 50% to about 90% w/w of the dry mix composition;

In some aspects, provided herein are methods of preparing any of the gluten-free dry mix compositions described herein, the methods comprising blending oat flour and millet flour are present in an amount of about 50% to about 99% weight/weight (w/w) of the dry mix composition; millet flour, buckwheat and/or oat flour and/or grain flour, and potato flour are collectively present in an amount of about 1% to about 50% w/w of the dry mix composition. This collective amount, in some embodiments texture additions in an amount of about 1% w/w of the dry mix composition. This collective amount, in some embodiments, includes buckwheat flour. This collective amount, in some embodiments, includes teff flour. This collective amount, in some embodiments, includes potato flour. This collective amount, in some embodiments, includes coconut flour. In some aspects, provided herein are methods of preparing any of the gluten-free dry mix compositions described herein, the methods comprising blending oat flour and millet flour are present in an amount of about 1% to about 50% weight/weight (w/w) of the dry mix composition; millet flour, buckwheat and/or oat flour and/or grain flour, and potato flour are collectively present in an amount of about 50% to about 99% w/w of the dry mix composition. This collective amount, in some embodiments texture additions in an amount of about 1% w/w of the dry mix composition. This collective amount, in some embodiments, includes buckwheat flour. This collective amount, in some embodiments, includes teff flour. This collective amount, in some embodiments, includes potato flour. This collective amount, in some embodiments, includes potato flour. This collective amount, in some embodiments, includes rice flour. This collective amount, in some embodiments, includes sweet rice flour.

In some aspects, provided herein are gluten-free food products comprising any of the gluten-free dry mix compositions described herein. In other aspects, provided herein are gluten reduced food products comprising any of the gluten-free dry mix compositions described herein.

In some aspects, provided herein are methods of preparing a food product based on a recipe that requires wheat, barley or rye flour and at least one other ingredient, said methods comprising combining any of the gluten-free dry mix compositions described herein with the at least one other ingredient in the recipe, wherein the wheat, barley, or rye flour ingredient is substituted with an equivalent amount of the gluten-free dry mix composition, and wherein the prepared food product is gluten-free. Said product could also include coconut flour.

In some embodiments, provided herein are methods of preparing a food product based on a recipe that requires wheat, barley or rye flour and at least one other ingredient, said method comprising combining oat flour, millet flour, millet flour, and potato flour, rice flour and/or sweet rice flour with the at least one other ingredient in the recipe, wherein the wheat, barley, or rye flour ingredient is substituted with an equivalent amount of oat flour, millet flour, and potato flour, rice flour and/or sweet rice flour, wherein a Gluten free food product is prepared. Said product could also include coconut flour.

In some aspects, provided herein are methods of preparing a food product based on a recipe that requires wheat, barley or rye flour and at least one other ingredient, said method comprising combining oat flour, millet flour, and potato flour, with the at least one other ingredient in the recipe, wherein the wheat, barley, or rye flour ingredient is substituted with an equivalent amount of oat flour, millet flour, and potato flour, and wherein a Gluten free food product is prepared. Said product could also include coconut flour.

In some aspects, provided herein are methods of preparing a food product based on a recipe that requires wheat, barley or rye flour and at least one other ingredient, said method comprising combining oat flour in an amount of about 20% to about 50% w/w of the dry mix composition; rice flour and/or sweet rice flour, millet flour in an amount of about 50% to about 80% w/w of the dry mix composition; with the at least one other ingredient in the recipe, wherein the wheat, barley, or rye flour ingredient is substituted with an equivalent amount oat flour in an amount of about 20% to about 50% w/w of the dry mix composition; rice flour and/or sweet rice flour, millet flour in an amount of about 50% to about 80% w/w of the dry mix composition; and wherein a gluten-free food product is prepared. In some aspects, provided herein are methods of preparing a food product based on a recipe that requires wheat, barley or rye flour and at least one other ingredient, said method comprising combining oat flour in an amount of about 50% to about 90% w/w of the dry mix composition; rice flour and/or sweet rice flour, millet flour in an amount of about 10% to about 50% w/w of the dry mix composition; with the at least one other ingredient in the recipe, wherein the wheat, barley, or rye flour ingredient is substituted with an equivalent amount oat flour in an amount of about 50% to about 90% w/w of the dry mix composition; rice flour and/or sweet rice flour, millet flour in an amount of about 10% to about 50% w/w of the dry mix composition; and wherein a gluten-free food product is prepared. In an aspect, in some embodiments, includes uses another less refined flour in place of the oat flour. In some aspects include at least one of xanthan gum, gaur gum, an emulsifier. In an aspect, in some embodiments, includes uses a less refined flour, for example teff, buckwheat, sorghum, an ancient grain. Said products could also include coconut flour. In some embodiments the amount of flour is significantly different than the original recipe. For example bread recipes often require different a amount of flour.

In some embodiments, the additional ingredients not listed in the recipe are excluded from the gluten-free food product and the amount of each ingredient in the recipe is not altered. In some embodiments, the additional ingredients not listed in the recipe are excluded from the gluten-reduced food product and the amount of each ingredient in the recipe is not altered.

In some aspects, provided herein are gluten-free food products prepared by any of the methods described herein. In other aspects, provided herein are gluten-reduced food products prepared by any of the methods described herein.

In some embodiments, the food product is selected from the group consisting of angel food cake, biscotti, biscuits, Boston cream pie, bread pudding, bread, dinner roll, dough, doughnuts, brownie, Bundt cake, cakes (e.g., wedding cakes), cinnamon rolls, cookie, cheese cake, chips, cracker, croissants, cupcakes, Danish, eclair, Florentine, French pastries, fruit cakes, fudge, coffee cakes, lemon squares, liqueur cake, loaf, muffin, noodles, pasta, pie dough, puff pastry turnover, pancake, pie, pineapple upside down cake, pizza dough, pretzels, quiche, quick bread, red velvet cake, sticky bun, strudel, stuffing, tart, tiramisu, torte, tres leche cake and trifle.

In some aspects, provided herein are gluten-reduced food products comprising any of the gluten-free dry mix compositions described herein and one or more additional gluten-containing ingredients. In some embodiments the amount of flour is significantly different than the original recipe. For example bread recipes often require a different amount of flour.

In some aspects, provided herein are prepackaged gluten-free food product kits comprising any of the gluten-free dry mix compositions described herein and a recipe or directions for obtaining a recipe for preparing a food product using the gluten-free dry mix composition. In other aspects, provided herein are prepackaged gluten-reduced food product kits comprising any of the gluten-free dry mix compositions described herein and a recipe or directions for obtaining a recipe for preparing a food product using the gluten-free dry mix composition.

In some embodiments, the kits further comprise at least one additional ingredient that is listed in the recipe.

In some aspects, provided herein are gluten-free dry mix compositions comprising rice flour, sweet rice flour, oat flour, millet, buckwheat flour, teff flour, potato flour, xanthan gum, maltodextrin, gaur gum. In some aspects, provided herein are gluten-free dry mix compositions comprising oat flour, millet, buckwheat flour, teff flour, potato flour, xanthan gum, maltodextrin, gaur gum. In some aspects, provided herein are gluten-free dry mix compositions comprising rice flour, sweet rice flour, oat flour, millet, buckwheat flour, teff flour, potato flour. In some aspects, provided herein are gluten-free dry mix compositions comprising flour, oat flour, millet, buckwheat flour, teff flour, potato flour. In some aspects, provided herein are gluten-free dry mix compositions comprising rice flour, oat flour, millet, buckwheat flour, teff flour, potato flour, xanthan gum, maltodextrin, gaur gum. In some aspects, provided herein are gluten-free dry mix compositions comprising rice flour, oat flour, millet, buckwheat flour, teff flour, potato flour. Said embodiments could also include coconut flour.

In some embodiments, different embodiments can be combined to create a blend that will work best for a certain recipe. By the way of example, but not limited to, an embodiment for cakes and an embodiment for cookies, can be combined for banana bread. By this method, a few flours and combine them in various rations for many more recipes. This method could also be used for other blend.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### DETAILED DESCRIPTION OF EMBODIMENTS

While embodiments are susceptible to various modifications and alternative forms, specifics thereof have been shown by way of example and drawings, and will be described in detail. It should be understood, however, that the scope herein is not limited to the particular embodiments described. On the contrary, the intention is to cover modifications, equivalents, and alternatives falling within the spirit and scope herein. Detailed Description

The embodiments described herein are not intended to be exhaustive or to limit the invention to the precise forms disclosed in the following detailed description. Rather, the embodiments are chosen and described so that others skilled in the art can appreciate and understand the principles and practices.

As referenced above, the market for gluten-free foods is quite substantial. However, gluten-free baked products typically exhibit poor machinability, dense loaf volume, gritty/brittle texture, and undesirable flavor.

As such, there is a substantial unmet need in the industry for gluten-free flour formulations that process well on traditional lines for producing products that have great taste, great texture, and increased shelf-stability.

The inventors herein have discovered that by combining a unique set of starches and hydrocolloids with unique physical, chemical, and functional properties it is possible to overcome the above challenges with gluten-free formulations.

As used herein, the term “shelf stable” with reference to a bread product is defined as a bread that is packed under normal packaging conditions (e.g., no modified atmospheric packaging (MAP)) and can be stored at room temperature for at least 14, 21, or 28 days.

Described herein are gluten-free dry mix compositions, which can be used to substitute gluten-containing flours, such as wheat, rye, and barley flour. The inventive gluten-free dry mix compositions may contain a mixture of gluten-free flour(s), starch(es), and thickening agent(s). In certain embodiments, the gluten-free dry mix compositions comprise rice flour, sweet rice flour, oat flour, millet flour, buckwheat flour, teff flour, potato flour. In certain embodiments, the inventive compositions comprise or consist essentially of super fine white rice flour, sweet rice flour, buckwheat and/or oat flour, millet flour, potato flour. In certain embodiments, the amount of oat flour in a gluten-free dry mix composition is about 10% to about 50% w/w of the composition, and the remaining components are present in an amount of about 50% to about 90% w/w of the composition. In some embodiments the composition will include rice flour. In some embodiments the composition will include sweet rice flour. In some embodiments the composition will include coconut flour. In certain embodiments, the amount of oat flour in a gluten-free dry mix composition is about 50% to about 90% w/w of the composition, and the remaining components are present in an amount of about 10% to about 50% w/w of the composition. In some embodiments the composition will include rice flour. In some embodiments the composition will include sweet rice flour. In certain embodiments, the gluten-free dry mix compositions comprise oat flour, millet flour, buckwheat flour, teff flour, potato flour. In certain embodiments, the inventive compositions comprise or consist essentially of super fine white rice flour, sweet rice flour, buckwheat and/or oat flour, millet flour, potato flour. In certain embodiments, the amount of oat flour in a gluten-free dry mix composition is about 10% to about 50% w/w of the composition, and the remaining components are present in an amount of about 50% to about 90% w/w of the composition. In some embodiments the composition will include rice flour. In some embodiments the composition will include sweet rice flour. In certain embodiments, the amount of oat flour in a gluten-free dry mix composition is about 50% to about 90% w/w of the composition, and the remaining components are present in an amount of about 10% to about 50% w/w of the composition. In some embodiments the composition will include rice flour. In some embodiments the composition will include sweet rice flour. In some embodiments the composition will include sweet rice flour. In particular embodiments, the amount of texture additives is about 1% w/w of the composition. In some embodiments the composition will include buckwheat flour. In some embodiments the composition will include teff flour. In some embodiments the composition will include grain bran. In some embodiments the composition will include grain germ. In some embodiments the composition will include less refined grain. In some embodiments the composition will include more refined grain. In some embodiments the composition will include coconut flour.

Also disclosed herein relate are gluten-free or gluten-reduced food products and methods of preparing such food products. Also disclosed are prepackaged gluten-free or gluten-reduced food product kits comprising any one of the gluten-free dry mix compositions described herein, a recipe for preparing a food product using the gluten-free dry mix composition, and, optionally, at least one additional ingredient (without or without gluten) that is listed in the recipe. In some embodiments the amount of flour is significantly different than the original recipe. For example bread recipes often require different a amount of flour.

In addition to the foregoing, other ingredients known to those of skill in the art can be included in the compositions to give a variety of desired properties, flavors and/or textures. Examples of these ingredients include flavoring and coloring agents, flavors, spices, and the like.

### Definitions

“Dry mix composition” refers to a substantially dry (no added water) mixture of edible ingredients, for example, flours, starches, gums, and the like. In some embodiments, the dry mix compositions described herein are gluten-free or gluten-reduced. A “gluten-free” composition refers to a composition substantially without (essentially free of) gluten protein. In some embodiments, a gluten-free dry mix composition and the ingredients/components used to prepare a composition provided herein are obtained from gluten-free facilities; that is, such facilities do not manufacture or use equipment that comes into contact with products that contain gluten.

“Equivalent amount” refers to a 1:1 substitution of one ingredient for another. For example, if a recipe requires 1 cup (about 1 cup) of wheat flour, an equivalent amount of the gluten-free dry mix composition is 1 cup (about 1 cup). Some recipes will require substantially different amount of flour, or an adjustment to the recipe will help.

“Food product” refers to a food, beverage, ingredient thereof or nutritional supplement that can be consumed to provide nutritional support for the body. A food product typically contains essential nutrients, such as carbohydrates, fats, proteins, vitamins, and/or mineral. A food product encompasses, but is not limited to, natural (unmodified) foods, organic foods, and composite foods made of one or more ingredients. A food product can be raw or cooked (e.g., baked, grilled, or fried). Any one of the food products described herein can be or comprise one or more fruit, vegetable, seed, grain, meat, fish, poultry, dairy product (e.g., milk, yogurt, cheese, etc.), or the like. Any one of the food products may also comprise added flavoring agents or sweeteners and the like. They may also include antioxidant food additives, such as ascorbic acid (i.e., vitamin C).

“Ginger” (also referred to as root ginger) means the rhizome of the plant Zingiber officinale and preparations made therefrom (e.g., ginger powder, ginger extract, etc.). Ginger, including for example root ginger or ginger powder (e.g., 100% ginger or a mixture of ginger and other spices), may optionally be present in any one of the gluten-free or gluten-reduced dry mix compositions described herein. Ginger can affect yeast activity, for example, it can increase yeast activity.

“Gluten” refers to an amorphous ergastic protein composite found in the endosperm of most cereals. It constitutes about 80% of the proteins contained in wheat and is composed of the proteins gliadine and glutenine. Gluten is responsible for the elasticity of kneaded dough which allows it to be leavened, as well as the ‘chewiness’ of baked products such as bagels. Gluten is found in most cereals (e.g., wheat, rye and barley) and products made with those cereals. Rice, soybean (soya), maize (corn), buckwheat, and sunflower seeds, for example, naturally do not contain gluten.

“Gluten-free diet” refers to a diet that excludes foods containing gluten protein. In some embodiments, a gluten-free diet may also be an organic diet.

“Gluten-free flour” refers to a powder or powder-like substance made of cereal grains, other seeds, or roots that are essentially free of gluten protein. The gluten-free flours used herein can be naturally gluten free or processed to eliminate its gluten content. As defined herein, “flour” encompasses ground or milled substances that are not fine; they can be coarse or even contain particles having a particle size, for example, of about 1 to about 100 microns or more, about 1 to about 50 microns, or about 50 to about 100 microns. In contrast, “powder,” “finely-ground powder,” or “superfine powder” refers to substances that are not coarse and can contain particles having a particle size, for example, of less than 50 microns, less than 25 microns, or less than 1 micron. In some embodiments, a distinction is made between, for example, milled white rice flour (e.g., particles greater than 1 micron) and finely-ground or superfine white rice powder (e.g., particles less than 1 micron). As used herein, “particle size” refers to the largest characteristic dimension (i.e. of a line passing through the geometric center of the particle e.g., diameter) that can be measured along any orientation of a particle (e.g., a polymer particle).

“Gluten-free food product” refers to a food product that does not contain (i.e. is essentially free of) gluten protein. In some embodiments, in addition to the gluten-free dry mix compositions described herein, gluten-free food products may comprise other gluten-free ingredients. Examples of other gluten-free ingredients include corn, potatoes, rice, and tapioca (derived from cassava, also referred to herein as tapioca flour, amaranth, arrowroot, montina, lupin, quinoa, sorghum jowar, taro, teff, chia seed, yam, beans, soybean, and nut flours, buckwheat, and gram flour, derived from chickpeas.

“Gluten-free ingredient” refers to any edible substance that forms or can be used to form part of a mixture (e.g., dry mixture) and that does not contain gluten protein. “Gluten-containing ingredient” refers to any edible substance that forms or can be used to form part of a mixture and that does contain (at least some) gluten protein.

“Gluten-reduced food product” refers to a food product that contains a reduced amount of gluten protein, relative to a food product made without taking measures to reduce the gluten content. For example, a gluten-reduced food product may contain any one of the gluten-free dry mix compositions described herein and additionally contain one or more ingredient that is not gluten-free. A gluten-reduced food product may also comprises a dry mix composition containing trace amounts of gluten protein.

“Guar gum” refers to a polysaccharide composed of the sugars galactose and mannose. Guar gum can be used as an emulsifier and/or as a stabilizer.

“Organic” refers to food products that are produced using methods that do not involve modern synthetic inputs such as synthetic pesticides and chemical fertilizers, no not contain genetically modified organisms, and are not processed using irradiation, industrial solvents, or chemical food additives. Any one of the food products (including, food, beverages, ingredients, dry mix compositions, and the like) may be organic or made with at least one organic component. In certain embodiments, organic food products or ingredients may meet the requirements of The Organic Foods Production Act (OFPA) of 1990 (Title 21 of P.L. 101-624, the Food, Agriculture, Conservation, and Trade Act of 1990) and/or may be certified as organic by an accredited certifying agent in the jurisdiction in which the food product or ingredient is produced and/or sold.

“Organoleptic properties” refers to the aspects of food or other substances as experienced by the senses, including taste, sight, smell, and touch. “Mouthfeel” refers to a product's physical and chemical interaction in the mouth and is evaluated from initial perception on the palate, to first bite, through mastication to swallowing and aftertaste. The gluten-free or gluten-reduced food products provided herein in certain embodiments have at least some organoleptic properties and mouthfeel comparable to their gluten-containing counterparts. For example, the organoleptic properties, including mouthfeel, of a chocolate chip cookie prepared with the gluten-free dry mix composition described herein may share substantially the same organoleptic properties of a chocolate chip cookie prepared following the same recipe but substituting wheat flour for the inventive gluten-free dry mix composition. The two cookies may look substantially the same, taste substantially the same, smell substantially the same, and/or feel substantially the same.

“Potato flour” refers to a Gluten free ground up potato. If the same process is followed for other vegetables, and then the result would be vegetable flour. Potato flour is different from potato starch.

“Prepackaged” food products or kits are those that are wrapped or packaged before marketing. Any one of the gluten-free or gluten-reduced dry mix compositions provided herein may be prepackaged. In instances wherein the inventive dry mix compositions are part of a prepackaged kit, such a kit can comprises a recipe or direction to obtain a recipe and/or one or more ingredients described in the recipe. A “recipe” means a set of instructions that describes how to prepare or make a food product, typically including a list of ingredients and step-by-step directions.

“Sorghum flour” refers to a gluten-free powder made from sorghum millet grain. Buckwheat, sorghum, oat flour, as well as many other grain flour are hearty grains. They can have very high fiber if ground whole, or less high fiber if it is hulled to various degrees. Other less refined or high refined flours may be included.

“Sweet rice flour” refers to a gluten-free powder made from high-starch, short-grain rice. Sweet rice flour can be used as a thickening agent.

“Wheat” means any Triticum species, including, but not limited to, T. aestivuin, T. monococcum, T. tauschii and T. turgidum. Thus, as used herein, the term “wheat” means any type of wheat including, but is not limited to, any cultivated wheat, any wild wheat, any wheat species, any intra- and inter-species wheat crosses, all wheat varieties, all wheat genotypes and all wheat cultivars. Cultivated wheats include, but are not limited to, einkom, durum and common wheats. “Barley” means a cereal grain derived from the annual grass Hordeum vulgare. “Rye” means a cereal grain (Secale cereale) that originated from either S. montanum or S. anatolicum and is closely related to wheat and barley. Wheat, barley, and rye each contain gluten protein.

“White rice flour” refers to a gluten-free powder made from polished rice (bran and germ removed). White rice flour can be used as a thickening agent. White rice may contain high levels of protein. In some embodiments, the white rice flour is superfine or finely-ground white rice flour (e.g., Authentic Foods White Rice Flour Superfine).

“Xanthan gum” refers to a high molecular weight polysaccharide gum produced by a pure-culture fermentation of a carbohydrate with Xanthomonas campestris, purified, for example, by recovery with ethanol or isopropanol, dried and milled. It contains D-glucose and D-mannose as the dominant hexose units, along with D-glucuronic acid and pyruvic acid, and may be prepared as the sodium, potassium or calcium salt. Xanthan gum, a natural thickener, may be used to add volume and viscosity to bread and other gluten-free baked goods.

### II. Compositions and Methods

Table 1 show the approximate ranges of ingredients for substitutes for some embodiments for cookies white all-purpose flour and whole wheat flours.

TABLE 1
White waffle flour Ingredients

| | |
|---|---|
| Rice flour | 45% to 70% |
| Glutinous rice flour | 0% to 10% |
| Oat flour | 20% to 40% |
| Millet flour | 4% to 10% |
| coconut flour | 0% to 4% |
| Potato flour | 0% to 4% |
| Seed flour(s) | 0% to 10% |
| Gluten free grain flour | 0% to 4% |

ranges are inclusive

TABLE 2
Higher fiber waffle flour Ingredients

| | |
|---|---|
| Rice flour | 0% to 20% |
| Glutinous rice flour | 0% to 2% |
| Oat flour | 60% to 90% |
| Millet flour | 5% to 30% |
| coconut flour | 0% to 20% |
| Potato flour | 0% to 4% |
| Teff flour | 0% to 10% |
| Buckwheat flour | 0% to 10% |
| Seed flour(s) | 0% to 10% |
| Gluten free grain flour | 0% to 4% |

ranges are inclusive

For additional embodiments, increase rice flour, then it may work for cakes as a substitute for white all-purpose flour and whole wheat flours.

For additional embodiments add specialty or new flour.

For additional embodiments stabilizers such as xanthan, gaur gum, and maltodextrin and adjust the other ingredients, you get a flour that will work for bread recipes or other recipes that need more structure. These examples illustrate the range of ingredients in Tables 3 and 4

TABLE 3
Bread white flour Ingredients

| | |
|---|---|
| Rice flour | 45% to 70% |
| Glutinous rice flour | 0% to 10% |
| Oat flour | 20% to 40% |
| Millet flour | 4% to 10% |
| coconut flour | 0% to 4% |
| Potato flour | 0% to 10% |
| Seed flour(s) | 0% to 10% |
| Gluten free grain flour | 0% to 4% |
| Xanthan gum | 0% to 10% |
| maltlodextrin | 0% to 10% |

ranges are inclusive

TABLE 4
Higher fiber bread flour Ingredients

| | |
|---|---|
| Rice flour | 0% to 20% |
| Glutinous rice flour | 0% to 2% |
| Oat flour | 60% to 90% |
| Millet flour | 5% to 30% |
| coconut flour | 0% to 20% |
| Potato flour | 0% to 10% |
| Teff flour | 0% to 10% |
| Buckwheat flour | 0% to 10% |
| Seed flour(s) | 0% to 10% |
| Gluten free grain flour | 0% to 4% |
| Xanthan gum | 0% to 10% |
| maltlodextrin | 0% to 10% |

ranges are inclusive

Certain aspects of the invention disclosed herein relate to gluten-free dry mix compositions comprising in certain embodiments oat flour at least one of white rice flour, sweet rice flour, millet flour, buckwheat, oat flour, coconut flour, potato flour, and optionally a gum. In some embodiments, guar gum is added. In some embodiments, xanthan gum is added. In some embodiments, maltodextrin is added. In some embodiments, the compositions further comprise ascorbic acid and/or ginger. In particular embodiments, provided herein are gluten-free or gluten-reduced dry mix compositions comprising or consisting essentially of white rice flour, sweet rice flour, oat flour, millet flour, buckwheat, potato flour, and a texture additive. In particular embodiments, provided herein are gluten-free or gluten-reduced dry mix compositions comprising or consisting essentially of white rice flour, sweet rice flour, oat flour, millet flour, buckwheat, coconut flour, potato flour. In particular embodiments, provided herein are gluten-free or gluten-reduced dry mix compositions comprising or consisting essentially of oat flour, millet flour, buckwheat, potato flour, and a texture additive. In particular embodiments, provided herein are gluten-free or gluten-reduced dry mix compositions comprising or consisting essentially of oat flour, millet flour, buckwheat, potato flour. In particular embodiments, provided herein are gluten-free or gluten-reduced dry mix compositions comprising or consisting essentially of oat flour, white rice flour, millet flour, buckwheat, potato flour and a texture additive. In particular embodiments, provided herein are gluten-free or gluten-reduced dry mix compositions comprising or consisting essentially of oat flour, millet flour, buckwheat, potato flour. Any one of these compositions may be suitable for use as a 1:1 substitute for gluten-containing flours, such as wheat, barley, and/or rye flour. Food products, related methods of preparing such food products, and prepackaged kits comprising the inventive dry mix compositions are also described herein. In some embodiments the amount of flour is significantly different than the original recipe. For example bread recipes often require different a amount of flour.

If someone can't eat oat, the amount refined flours, for example, but not limited to as buckwheat, millet, could be adjusted to compensate. In some embodiment, it is mostly oat flour and coconut flour. In some embodiment, it is mostly oat flour and millet flour.

In some embodiments, different embodiments can be combined to create a blend that will work best for a certain recipe. By the way of example, but not limited to, an embodiment for cakes and an embodiment for cookies, can be combined for banana bread. By this method, a few flours and combine them in various rations for many more recipes. Examples of factors that could vary the recipe that
could depend on availability of ingredients or preferences.
could depend on availability of preferences. What flavor do you prefer, hearty? Mild?
Variation in type of oat, or other ingredients. Some kinds of millet seeds are milder, so you may want have a higher percentage.
The more complete hulled the buckwheat the higher the percent that can be used
Finest of a grind on the flours, may affect the required level of other ingredients
How refined the flours
level of fiber desired

TABLE 5
In some embodiments, the percent of ingredients is as follows;
At least two of;

| | |
|---|---|
| oat | 0 to 1%, 1 to 2%, . . . , 89 to 90% |
| millet | 0 to 1%, 1 to 2%, . . . , 29 to 30% |
| potato flour | 0 to 1%, 1 to 2%, . . . , 9 to 10% |
| buckwheat flour | 0 to 1%, 1 to 2%, . . . , 39 to 40% |
| coconut flour | 0 to 1%, 1 to 2%, . . . , 19 to 20% |

Optionally;

| | |
|---|---|
| Rice flour | 0 to 1%, 1 to 2%, . . . , 79 to 80% |
| glutinous rice | 0 to 1%, 1 to 2%, . . . , 29 to 30% |
| teff flour | 0 to 1%, 1 to 2%, . . . , 19 to 20% |
| grain flours | 0 to 1%, 1 to 2%, . . . , 19 to 20% |
| seed flours | 0 to 1%, 1 to 2%, . . . , 19 to 20% |
| xanthan gum | 0 to 0.1%, 0.1 to 2%, . . . , 3.9 to 4% |
| gaur gum | 0 to 0.1%, 0.1 to 2%, . . . , 3.9 to 4% |
| maltodextrin | 0 to 0.1%, 0.1 to 2%, . . . , 3.9 to 4% |
| ranges are inclusive | |

In certain embodiments, other gluten free flours are included such as teff flour, ancient grain flours, amaranth, teff, quinoa. In certain embodiments, whole or ground seeds could also be added. In certain embodiments, barley and other non-wheat flours for those who have a problem with wheat but not all glutens. In certain embodiments, comprising at least one of the following; xanthan gum, gaur gum, maltodextrin, dextrin, emulsifiers, psyllium, and stabilizers. In certain embodiments, comprising at least one of the following; soy, milk, whey, protein isolates, or high proteins substances to make a higher proteins flour. In certain embodiments, tapioca flour is excluded from the dry mix compositions described herein. In certain embodiments, bean flour is excluded from the dry mix compositions described herein.

In some embodiments, the dry mix compositions do not comprise any added starch. In some embodiments, the dry mix compositions do not comprise any added modified starch. In some embodiments, the dry mix compositions do not comprise a bean flour. In some embodiments, the dry mix compositions do not comprise a gum. In some embodiments, the dry mix compositions do not comprise sorghum flour. In some embodiments, the dry mix compositions do not comprise any added corn starch. In some embodiments, the dry mix compositions do not comprise any added tapioca. In some embodiments, the dry mix compositions do not comprise any added xanthan gum. In some embodiments, the dry mix compositions do not comprise any added gaur gums. In some embodiments, the dry mix compositions do not comprise any added gums. In some embodiments, the dry mix compositions do not comprise any added rice. In certain embodiments, tapioca flour is excluded from the dry mix compositions described herein. A composition for making a gluten-free product, comprising a gluten-free gas-retaining polymer, and a gluten-free setting polymer. A composition for gluten-free baked product comprising a native starch pregelatinized or precooked, fibers of plant origin chosen from fibers legume.

Other aspects provided herein relate methods of preparing a food product having a recipe that requires wheat, barley and/or rye flour and at least one other ingredient, the methods comprising combining the gluten-free dry mix composition of any one of the embodiments described herein with at least one other ingredient in the recipe. In some embodiments, a gluten-free dry mix composition is used to substitute for wheat, barley, and/or rye flour ingredients in the recipe. In other embodiments, a gluten-free dry mix composition substitutes for only a portion of the wheat, barley, or rye flour ingredients in the recipe. In such embodiments, a gluten-reduced (rather than a gluten-free) food product is prepared. For example, in a recipe requiring 2 cups of wheat flour, 1 of the 2 cups of wheat flour can be substituted with (replaced by) any one of the gluten-free dry mix compositions described herein. In some embodiments the amount of flour is significantly different than the original recipe. For example bread recipes often require different a amount of flour.

Still other aspects provided herein relate to methods of preparing a food product based on a recipe that requires wheat, barley and/or rye flour and at least one other ingredient, the methods comprising combining oat flour, millet flour with at least one other ingredient in the recipe. In some embodiments, the methods further comprise combining rice flour In some embodiments, the methods further comprise combining sweet rice flour. In some embodiments, the methods further comprise combining teff flour. In some embodiments, the methods further comprise combining buckwheat flour. In some embodiments, the methods further comprise combining ascorbic acid and/or ginger. In some embodiments, the methods further comprise combining xanthan gum. In some embodiments, the methods further comprise combining gaur gum. In some embodiments, the methods further comprise combining maltodextrin.

In certain embodiments, additional ingredients not listed in the recipe are excluded during preparation of the food product (and excluded from the final food product) and the amount of each ingredient in the recipe is not altered. It is known to one of ordinary skill in the art that when Gluten free flour blends or flours, such as sorghum flour, are used in place of, e.g., wheat flour, it is often necessary to alter other ingredients in the recipe to compensate for the properties that are lost or negatively affected by omitting gluten. For example, extra oil or shortening may be necessary to impart moisture to the wheat-free food product, an extra egg or two may be required to improve smoothness and crumb structure, or extra baking powder and/or baking soda may be necessary to boost rising properties. Such “altered” amounts and/or types of ingredients may not be necessary or be reduced with the Gluten free or gluten-reduced dry mix compositions of certain embodiments described herein. Certain embodiments of the inventive compositions may be used as a direct 1:1 substitution (about 1:1) for gluten-based flours, such as wheat, barley, and/or rye flour, without the addition of extra ingredients/amounts of required ingredients.

Yet other aspects provided herein relate to gluten-free or gluten-reduced food products. Gluten-free food products may comprise any one of the gluten-free dry mix compositions provided herein or may comprises the ingredients used to make the gluten-free dry mix compositions. Such food products may be gluten-free or substantially gluten-free. Gluten-reduced food products may comprise any one of the gluten-free dry mix compositions provided herein or may comprise ingredients used to make the gluten-free dry mix compositions, and additionally, one or more ingredients comprising gluten. Examples of gluten-free or gluten-reduced food products include, but are not limited to, angel food cake, biscotti, biscuits, Boston cream pie, bread pudding, bread, dinner roll, dough, doughnuts, brownie, bundt cake, cakes, cinnamon rolls, cookie, cheese cake, chips, cracker, croissants, cupcakes, danish, eclair, florentine, French pastries, fruit cakes, fudge, coffee cakes, lemon squares, liqueur cake, loave, muffin, noodles, pasta, pie dough, puff pastry turnover, pancake, pie, pineapple upside down cake, pizza dough, pretzels, quiche, quick bread, red velvet cake, sticky bun, strudel, stuffing, tart, tiramisu, torte, tres leche cake, trifle, and wedding cake.

Aspects provided herein also relate to prepackaged dry mixes comprising any one of the gluten-free dry mix compositions described herein, optionally also including one or more additional ingredients (e.g., gluten-free ingredients), and a recipe or directions for obtaining a recipe for preparing a food product using the gluten-free dry mix composition and the additional ingredients.

The function and advantage of these and other embodiments of the present invention may be more fully understood from the examples below. The following examples, while illustrative of certain embodiments of the invention, do not exemplify the full scope of the invention.

### EXAMPLES

### Example 1. Chocolate Chip Cookies

Ingredients: 2¼ cups gluten-free dry mix composition (finely-ground white rice flour, sweet rice flour, potato flour, buckwheat flour, teff flour, oat flour, millet flour, and ginger), 1 teaspoon baking soda, 1 teaspoon salt, 1 cup (2 sticks) butter, softened, ¾ cup granulated sugar, ¾ cup packed brown sugar, 1 teaspoon vanilla extract, 2 large eggs, 2 cups (12-oz. pkg.) NESTLE® TOLL HOUSE® Semi-Sweet Chocolate Morsels, 1 cup chopped nuts. Directions: Preheat oven to 375° F. Combine flour, baking soda and salt in small bowl. Beat butter, granulated sugar, brown sugar and vanilla extract in large mixer bowl until creamy. Add eggs, one at a time, beating well after each addition. Gradually beat in flour mixture. Stir in morsels and nuts. Drop by rounded tablespoon onto ungreased baking sheets. Bake for 9 to 11 minutes or until golden brown. Cool on baking sheets for 2 minutes; remove to wire racks to cool completely.

### Example s Sour Cream Coffee Cake

Ingredients: ¼ cup butter, 1 cup sugar, 1 cup sour cream, 1 teaspoon vanilla, 2 eggs, 2 cups gluten-free dry mix composition (finely-ground white rice flour, sweet rice flour, potato flour, buckwheat flour, teff flour, oat flour, millet flour, coconut flour, and ginger), finely-ground white rice flour, sweet rice flour, potato starch, sorghum flour, xanthan gum, cornstarch, ascorbic acid, and ginger), 1 teaspoon baking powder, and 1 teaspoon baking soda. Nut topping: ¼ teaspoon cinnamon, ¼ cup chopped walnuts, and ¼ cup firmly packed brown sugar. Directions: spoon ¼ of the cake batter into the pan. Sprinkle with ¼ of the nut topping. Spoon in remaining batter and top with remaining nut topping. Bake at 375° F. for 30-45 minutes depending on pan size.

### Example 3. Carrot Cake

Ingredients: 2 cups gluten-free dry mix composition (potato flour, buckwheat flour, teff flour, oat flour, millet flour, and ginger), 2 cups sugar, 1 teaspoon baking powder, 1 teaspoon baking soda, 1 teaspoon ground cinnamon, 3 cups of finely shredded carrot, 1 cup cooking oil, and 4 eggs.

Directions: preheat oven to 350° F. In a bowl, combine flour, sugar, baking powder, baking soda, and cinnamon. Add carrot, oil, and eggs. Beat with an electric mixer until all ingredients are combined. Pour into two greased and floured 9×1¼ inch round baking pans. Bake in a 350° F. oven for 20-35 minutes. Cool on wire rack for 10 minutes. Remove cakes from pan and cool thoroughly.

In some embodiments the amount of flour is significantly different than the original recipe. For example bread recipes often require different amount of flour. For example for pizza dough from allrecipes.com, the original recipe requires about 300 grams, but the gluten free recipes requires about 280 grams. In some recipes, the difference is even greater.

While several embodiments of the invention have been described and illustrated herein, those of ordinary skill in the art will readily envision a variety of other means and structures for performing the functions and/or obtaining the results or advantages described herein, and each of such variations, modifications and improvements is deemed to be within the scope of the present invention. More generally, those skilled in the art would readily appreciate that all parameters, dimensions, materials, and configurations described herein are meant to be exemplary and that actual parameters, dimensions, materials, and configurations will depend upon specific applications for which the teachings of the present invention are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described. The present invention is directed to each individual feature, system, material and/or method described herein. In addition, any combination of two or more such features, systems, materials and/or methods, provided that such features, systems, materials and/or methods are not mutually inconsistent, is included within the scope of the present invention.

In the claims (as well as in the specification above), all transitional phrases or phrases of inclusion, such as “comprising,” “including,” “carrying,” “having,” “containing,” “composed of,” “made of,” “formed of,” “involving” and the like shall be interpreted to be open-ended, i.e. to mean “including but not limited to” and, therefore, encompassing the items listed thereafter and equivalents thereof as well as additional items. Only the transitional phrases or phrases of inclusion “consisting of” and “consisting essentially of” are to be interpreted as closed or semi-closed phrases, respectively. The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified. Thus, as a non-limiting example, a reference to “A and/or B” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood, unless otherwise indicated, to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements that the phrase “at least one” refers to, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In some of the above embodiments, wherein said comprises only of flours that are grain, seed, vegetable flours, or spices.

This invention would include;

1. A gluten-free dry mix composition, comprising of oat flour; millet flour; and potato flour.

2. The gluten-free dry mix composition of 1, comprising of oat flour, millet flour, potato flour and one or more of: white rice flour; sweet rice flour; ginger; buckwheat flour; teff flour, a whole or less refined grain flour.

3. The gluten-free dry mix composition of 1, comprising of oat flour, millet flour, potato flour wherein oat flour, millet flour, and potato flour is present in an amount of at least about 20% w/w of the dry mix composition.

4. The gluten-free dry mix composition of 3, wherein the oat flour is present in an amount of about 60% to about 90% w/w of the dry mix composition; millet flour in the range of 10 to 30 percent by weight; potato flour in the range of 0 to 4 percent by weight;

5. The gluten-free dry mix composition of 4, wherein the oat flour is present in an amount of about 60% to about 90% w/w of the dry mix composition; millet flour in the range of 10 to 30 percent by weight; potato flour in the range of 0 to 4 percent by weight; (i) buckwheat flour in the range of 0 to 4 percent by weight, (j) teff flour in the range of 0 to 4 percent by weight

6. The gluten-free dry mix composition of 5, wherein the oat flour is present in an amount of about 60% to about 90% w/w of the dry mix composition; millet flour in the range of 10 to 30 percent by weight; potato flour in the range of 0 to 4 percent by weight; (i) xanthan gum flour in the range of 0 to 4 percent by weight, (j) maltodextrin flour in the range of 0 to 4 percent by weight, (k) gaur gum flour in the range of 0 to 4 percent by weight

7. The gluten-free dry mix composition of 3, wherein the oat flour is present in an amount of about 60% to about 90% w/w of the dry mix composition; millet flour in the range of 10 to 30 percent by weight; potato flour in the range of 0 to 4 percent by weight; (i) xanthan gum flour in the range of 0 to 4 percent by weight, (j) maltodextrin flour in the range of 0 to 4 percent by weight, (k) gaur gum flour in the range of 0 to 4 percent by weight; (l) buckwheat flour in the range of 0 to 4 percent by weight, (m) teff flour in the range of 0 to 4 percent by weight

8. The gluten-free dry mix composition of 7, wherein rice flour in the range of 0 to 25 percent inclusively by weight; oat flour in the range of 60 to 90 percent by weight; millet flour in the range of 10 to 30 percent by weight; glutinous rice flour in the range of 0 to 2 percent by weight; potato flour in the range of 0 to 4 percent by weight; a grain flour in the range of 0 to 4 percent inclusively by weight; a seed flour in the range of 0 to 4 percent inclusively by weight; xanthan gum in the range of 0 to 2 percent inclusively by weight; gaur gum in the range of 0 to 2 percent inclusively by weight; and maltodextrin in the range of 0 to 2 percent inclusively by weight.

9. The gluten-free dry mix composition of 1, wherein it also comprising white rice flour.

10. The gluten-free dry mix composition of 9, wherein it also comprising sweet rice flour.

11. The gluten-free dry mix composition of 9 comprising: rice flour in the range of 45 to 70 percent by weight; oat flour in the range of 10 to 30 percent by weight; millet flour in the range of 4 to 10 percent by weight; potato flour in the range of 0 to 4 percent by weight;

12. The gluten-free dry mix composition of 11 comprising: rice flour in the range of 45 to 70 percent by weight; oat flour in the range of 10 to 30 percent by weight; millet flour in the range of 4 to 10 percent by weight; potato flour in the range of 0 to 4 percent by weight; buckwheat flour in the range of 0 to 4 percent by weight, teff flour in the range of 0 to 4 percent by weight, sweet rice flour in the range of 0 to 20 percent by weight

13. The gluten-free dry mix composition of 12 comprising: rice flour in the range of 45 to 70 percent by weight; oat flour in the range of 10 to 30 percent by weight; millet flour in the range of 4 to 10 percent by weight; potato flour in the range of 0 to 4 percent by weight; (i) xanthan gum flour in the range of 0 to 4 percent by weight, (j) maltodextrin flour in the range of 0 to 4 percent by weight, (k) gaur gum flour in the range of 0 to 4 percent by weight

14. The gluten-free dry mix composition of 13 comprising: rice flour in the range of 45 to 70 percent by weight; oat flour in the range of 10 to 30 percent by weight; millet flour in the range of 4 to 10 percent by weight; potato flour in the range of 0 to 4 percent by weight; (i) xanthan gum flour in the range of 0 to 4 percent by weight, (j) maltodextrin flour in the range of 0 to 4 percent by weight, (k) gaur gum flour in the range of 0 to 4 percent by weight (i) buckwheat flour in the range of 0 to 4 percent by weight, (j) teff flour in the range of 0 to 4 percent by weight; sweet rice flour in the range of 0 to 20 percent by weight

15. The gluten-free dry mix composition of 14 comprising: rice flour in the range of 45 to 70 percent by weight; oat flour in the range of 20 to 30 percent by weight; millet flour in the range of 4 to 10 percent by weight; glutinous rice flour in the range of 0 to 10 percent inclusively by weight; potato flour in the range of 0 to 4 percent by weight; a grain flour in the range of 0 to 4 percent inclusively by weight; a seed flour in the range of 0 to 4 percent inclusively by weight; xanthan gum in the range of 0 to 2 percent inclusively by weight; gaur gum in the range of 0 to 2 percent inclusively by weight; and maltodextrin in the range of 0 to 2 percent inclusively by weight.

16. The gluten-free dry mix composition of 1 comprising: rice flour in the range of 0 to 80 percent inclusively by weight; oat flour in the range of 10 to 90 percent by weight; millet flour in the range of 0.01 to 30 percent by weight; glutinous rice flour in the range of 0 to 10 percent inclusively by weight; potato flour in the range of 0 to 10 percent by weight; a grain flour in the range of 0 to 10 percent inclusively by weight; a seed flour in the range of 0 to 10 percent inclusively by weight; xanthan gum in the range of 0 to 2 percent inclusively by weight; gaur gum in the range of 0 to 2 percent inclusively by weight; and maltodextrin in the range of 0 to 2 percent inclusively by weight.

17. A gluten-free dry mix composition, comprising of millet flour, potato flour, a rice flour and at least one less refined grain flour;

18. The gluten-free dry mix composition of 17, comprising of buckwheat flour, millet flour, potato flour, white rice flour; sweet rice flour; ginger;

19. The gluten-free dry mix composition of 18, wherein the rice flour is about 30 to 40% of the blend and the sweet rice is about 30% to 40% of the blend

20. The gluten-free dry mix composition of 19, wherein the rice is present in an amount of about 30 to 40 percent by weight; the sweet rice is present in an amount of about 30 to 40 percent by weight; millet flour in the range of 10 to 20 percent by weight; potato flour in the range of 0 to 4 percent by weight

With some of the above embodiments gluten-free or gluten reduced food product comprising the gluten-free dry mix composition of any one of any of the above claims.

In some embodiments, different embodiments can be combined to create a blend that will work best for a certain recipe. By the way of example, but not limited to, an embodiment for cakes and an embodiment for cookies, can be combined for banana bread. By this method, a few flours and combine them in various rations for many more recipes. Gluten-free and gluten-reduced food products further comprise ginger.

A food product based on a recipe that requires wheat, barley or rye flour and at least one other ingredient, said method comprising combining the gluten-free dry mix composition of any one of any of the above embodiments with the at least one other ingredient in the recipe, wherein the wheat, barley, or rye flour ingredient is substituted with an equivalent amount of the gluten-free dry mix composition, and wherein the prepared food product is gluten-free.

In some of the above embodiments, wherein additional ingredients not listed in the recipe are excluded from the gluten-free food product and wherein the amount of each ingredient in the recipe is not altered.

With some of the above embodiments, gluten-free food product using any of the above embodiments wherein the food product is selected from the group consisting of: angel food cake, biscotti, biscuits, Boston cream pie, bread pudding, bread, dinner roll, dough, doughnuts, brownie, bundt cake, cakes, cinnamon rolls, cookie, cheese cake, chips, cracker, croissants, cupcakes, danish, eclair, florentine, French pastries, fruit cakes, fudge, coffee cakes, lemon squares, liqueur cake, loaf, muffin, noodles, pasta, pie dough, puff pastry turnover, pancake, pie, pineapple upside down cake, pizza dough, pretzels, quiche, quick bread, red velvet cake, sticky bun, strudel, stuffing, tart, tiramisu, torte, tres leche cake, trifle, and wedding cake.

A gluten-reduced food product comprising the gluten-free dry mix composition of any one of any of the above embodiments and one or more additional gluten-containing ingredients.

A prepackaged gluten-free or gluten reduced food product kit comprising the gluten-free dry mix composition of any of the above embodiments and a recipe or directions for obtaining a recipe for preparing a food product using the gluten-free dry mix composition. The kit, wherein the kit further comprises at least one additional ingredient that is listed in the recipe.

A gluten-free blend that is mass produced comprising the gluten-free dry mix composition of any of the above embodiments.

In cases where the present specification and a document incorporated by reference and/or referred to herein include conflicting disclosure, and/or inconsistent use of terminology, and/or the incorporated/referenced documents use or define terms differently than they are used or defined in the present specification, the present specification shall control.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration to. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

Aspects have been described with reference to various specific and preferred embodiments and techniques. However, it should be understood that many variations and modifications may be made while remaining within the spirit and scope herein.

PatentCited

| Patent | Filing date | Publication date | Applicant | Title |
|---|---|---|---|---|
| US20050158446 * | Jan 21, 2004 | Jul 21, 2005 | Lester Linda K. | Savory gluten-free foods |
| U520090098270 * | Aug 13, 2008 | Apr 16, 2009 | Cargill, Incorporated | System for gluten |
| | | | | replacement in food products |
| U520090123627 * | Oct 23, 2008 | May 14, 2009 | Shepard Jules E D | Gluten-free flour |
| | | | | composition |
| U520100297323 * | Jan 8, 2010 | Nov 25, 2010 | Solazyme, Inc. Gluten-free | Foods Containing |
| | | | | Microalgae |
| W02013043659A1 | Sep 19, 2012 | Mar 3, 2013 | Stefanie Papanastasiou | Gluten-free dry mix |
| | | | | composition |
| U520090098270 * | Aug 13, 2008 | Apr 16, 2009 | Cargill, Incorporated | System for gluten |
| | | | | replacement in food products |
| U520090123627 * | Oct 23, 2008 | May 14, 2009 | Shepard Jules E D | Gluten-free flour |
| | | | | composition |
| U520070160728A1 | Oct 13, 2005 | Jul 12, 2007 | Noel Rudy | Gluten-free food products |
| | | | | including deflavored bean powder |
| W02012115781A1 | Feb 2, 2011 | Aug 8, 2012 | Li Zhang | Composition comprising gluten- |
| | | | | free cereal flour |
| W02011062507A1 | Nov 18, 2010 | May 26, 2011 | Sudrud Sorensen | Dough for gluten-free |
| | | | | pastries, method for production for such |
| | | | | gluten-free pastries, set for production of |
| | | | | gluten-free pastries and use of such |
| | | | | dough for production of gluten-free |
| | | | | pastries |
| U520110027421 * | Jun 25, 2010 | Feb 3, 2011 | U&S Unismack S.A. | Gluten-free food |
| | | | | compositions comprising cheese, starch, and |
| | | | | gluten-free flour and methods for |
| | | | | making the same |
| CN102018011A | Oct 28, 2010 | Apr 20, 2011 | | |
| U520130040016A1 | Aug 15, 2012 | Fey 14, 2013 | Larua Lane Becker | Allergen-free |
| | | | | composistions |
| W02014035470A1 | Mar 8, 2013 | Mar 6, 2014 | | High protein meal and flour |
| | | | | compostions and methods |
| EP20120716521 | Mar 16, 2012 | May 4, 2016 | Karsten KarcherGluten-free composition for | |
| | | | bakery | |
| U520110117246 * | Jul 15, 2009 | May 19, 2011 | Cargill, Incorporated | Composition for |
| | | | | preparing improved gluten-free or |
| | | | | gluten-reduced bakery products |
| W02014193417A1 * | May 31, 2013 | Dec 4, 2014 | General Mills, Inc. | Ready-to-bake gluten- |
| | | | | free pizza dough formulations |

| | |
|---|---|
| U.S. Classification | 426/72, 426/622, 426/637, A21D13/066 |
| International Classification | A23L1/2165, A23L1/10, A21D10/00, A23L1/00, C08L3/00 |
| Cooperative Classification | A23L1/2165, A23V2002/00, A23L1/1041, A21D10/005, A23L1/1041, |
| | A21D13/04, C08L99/00, A21D2/183, A21D2/186, A21D13/066 |

Composition comprising gluten-free cereal flour
EP 2677873 A1
CN103369965A, CN1033699656, U520130323354, W02012115781A1
Gluten-free composition for bakery
EP 2685833 B1

1. A gluten-free dry mix composition, comprising of oat flour and millet flour; wherein oat flour and millet flour is present in an amount of at least about 10% w/w of the dry mix composition;

2. The gluten-free dry mix composition of claim 1, wherein oat flour, millet flour is present in an amount of at least about 30% w/w of the dry mix composition;

3. The gluten-free dry mix composition of claim 2, wherein oat flour and millet flour is present in an amount of at least about 50% w/w of the dry mix composition;

4. The gluten-free dry mix composition of claim 3, wherein oat flour and millet flour is present in an amount of at least about 70% w/w of the dry mix composition;

5. The gluten-free dry mix composition of claim 4, wherein the oat flour is present in an amount of about 50% to about 90% w/w of the dry mix composition; millet flour in the range of 2 to 20 percent by weight;

6. The gluten-free dry mix composition of claim 1, comprising of and one or more of: white rice flour; sweet rice flour; coconut flour; ginger; buckwheat flour; teff flour, a less refined grain flour, a less refined seed flour, potato flour;

7. The gluten-free dry mix composition of claim 6, comprising potato flour;

8. The gluten-free dry mix composition of claim 6, comprising coconut flour;

9. The gluten-free dry mix composition of claim 7, comprising coconut flour;

10. The gluten-free dry mix composition of claim 1, wherein it is also comprising xanthan gum;

11. The gluten-free dry mix composition of claim 1, wherein it is also comprising maltodextrin;

12. The gluten-free dry mix composition of claim 6, comprising oat flour, millet flour, buckwheat flour; teff flour, and potato flour;

13. The gluten-free dry mix composition of claim 12, comprising oat flour, millet flour, buckwheat flour; teff flour, and potato flour; coconut flour;

14. The gluten-free dry mix composition of claim 1 comprising: oat flour in the range of 50 to 90 percent by weight; millet flour in the range of about 10 to 20 percent by weight;

15. The gluten-free dry mix composition of claim 1; comprising: rice flour, sweet rice flour, oat flour, millet flour; potato flour;

16. The gluten-free dry mix composition of claim 16 comprising: rice flour in the range of 40 to 70 percent by weight; oat flour in the range of 10 to 50 percent by weight; millet flour in the range of 4 to 14 percent by weight; potato flour in the range of 0 to 4 percent by weight;

17. The gluten-free dry mix composition of claim 15, comprising rice flour; sweet rice flour; oat flour, millet flour, buckwheat flour; teff flour, and potato flour;

18. Product which include oat flour and millet flour in an amount of at least about 10% w/w of the portion of said product which comprises flours; including mixes, partially made item like dough, and ready to eat products.

19. A gluten-free dry mix composition, comprising of rice flour, millet flour, potato flour, and at least one less refined grain flour;

20. The gluten-free dry mix composition of claim 17, comprising of buckwheat flour, millet flour, potato flour, white rice flour; sweet rice flour; ginger;
